(19) United States
(12) Patent Application Publication
(10) Pub. No.: US 2008/0285469 A1
(43) Pub. Date: Nov. 20, 2008

(54) COMPUTER REPLACING REDUNDANT COMMUNICATION ROUTES, AND PROGRAMS AND METHOD FOR THE SAME

(76) Inventors: Masaru Toda, Yokohama (JP); Hokuto Kobayashi, Yokohama (JP); Michihiro Uchishiba, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/923,883

(22) Filed: Oct. 25, 2007

(30) Foreign Application Priority Data
May 14, 2007 (JP) 2007-127761

(51) Int. Cl. G06F 11/30

(52) U.S. Cl. 370/244

(57) ABSTRACT

Computer including at least a first and a second interface coupled to a network. The first interface holds a first address, and the second interface holds the first address and a second address. The computer transmits a packet having the first address as a source address from the first interface, and transmits a packet having the second address as a source address from the second interface. When it is determined that a state of a communication route coupled to the first interface is not normal, the computer transmits a packet having the first address as a source address from the second interface.

### CLAIM OF PRIORITY

The present application claims priority from Japanese application JP2007-127761 filed on May 14, 2007, the content of which is hereby incorporated by reference into this application.

### BACKGROUND OF THE INVENTION

Technology disclosed in this specification relates to the control of communication by computers connected to a network, and more particularly to the redundancy of communication routes.

As a result of an advance in network technology, a computer system comprising plural computers communicatably connected by a network is realized. Technology is known which makes communication routes on a network redundant to increase fault tolerance of such a computer system.

For example, in U.S. Pat. No. 6,594,227B1, a computer (communication station) that includes two independent network adaptors (NA) connected to a network is disclosed. The two NAs are interfaces (e.g., so-called network interface cards) that are connected to the network and communicate with other computers connected to the network. When a fault occurs in a communication route that passes through one NA, communication is executed through the other NA. By thus making the communication route redundant, a highly fault-tolerant computer system can be realized which operates even when a fault occurs in one point of the network.

According to U.S. Pat. No. 6,594,227B1, different Media Access Control (MAC) addresses are assigned to two NAs included in one computer. For example, assume that one of the two NAs is an active NA used for transmission/reception of user packets, and the other is a standby NA used for transmission/reception of user packets when a communication route connected to the active system fails. In this case, since MAC addresses assigned to the active NA and the standby NA are different, the standby NA cannot take over the active NA to transmit and receive user packets until the MAC address of the standby system NA is rewritten to the same value as the MAC address of the active NA.

Alternatively, an identical MAC address can be assigned beforehand to the active NA and the standby NA. In this case, however, the active NA and the standby NA use an identical MAC address to transmit a diagnosis packet. When the network is connected to a switching hub, a correspondence table of MAC addresses and ports held by the switching hub is frequently updated based on the source MAC addresses of diagnosis packets. As a result, packets addressed to an active NA may not arrive in the active NA. For example, when the switching hub has received a diagnosis packet transmitted from the standby NA, the MAC address and the port number of the standby NA are registered in the correspondence table. After that, when the switching hub receives a packet addressed to the active NA, it transmits the packet to a network to which the standby NA is connected. As a result, the packet may not arrive in the active NA.

### SUMMARY OF THE INVENTION

According to a representative invention disclosed in this application, there is provided a computer comprising plural interfaces coupled to a network, a processor coupled to the plural interfaces, and a storage device coupled to the processor, wherein the plural interfaces include a first interface and a second interface, wherein the first interface holds a first address, and when the destination address of a packet received by the first interface matches the first address, transmits the received packet to the processor, wherein the second interface holds the first address and a second address, and when the destination address of a packet received by the second interface matches the first address or the second address, transmits the received packet to the processor, and wherein the processor: transmits a packet having the first address as a source address from the first interface; transmits a packet having the second address as a source address from the second interface; and when it is determined that a state of a communication route on the network that is coupled to the first interface is not normal, transmits a packet having the first address as a source address from the second interface.

### BRIEF DESCRIPTION OF THE DRAWINGS

FIG. 1 is a block diagram showing a hardware configuration of a computer of an embodiment of this invention.

FIG. 2 is a functional block diagram of the computer of the embodiment of this invention.

FIG. 3 is an explanatory diagram of an active information table of the embodiment of this invention.

FIG. 4 is an explanatory diagram of a diagnosis information table of the embodiment of this invention.

FIG. 5 is a flowchart showing user packet transmission processing executed by a communication controller of the embodiment of this invention.

FIG. 6 is a flowchart showing diagnosis packet transmission processing executed by the communication controller of the embodiment of this invention.

FIG. 7 is a flowchart showing route checking processing executed by the communication controller of the embodiment of this invention.

FIG. 8 is a flowchart showing active replacement processing executed by the communication controller of the embodiment of this invention.

FIG. 9 is a flowchart showing MAC address takeover processing executed by the communication controller of the embodiment of this invention.

FIG. 10 is a flowchart showing an example of execution timing of the MAC address takeover processing in the embodiment of this invention.

### DETAILED DESCRIPTION OF PREFERRED EMBODIMENTS

Embodiments of this invention will be described with reference to the drawings.

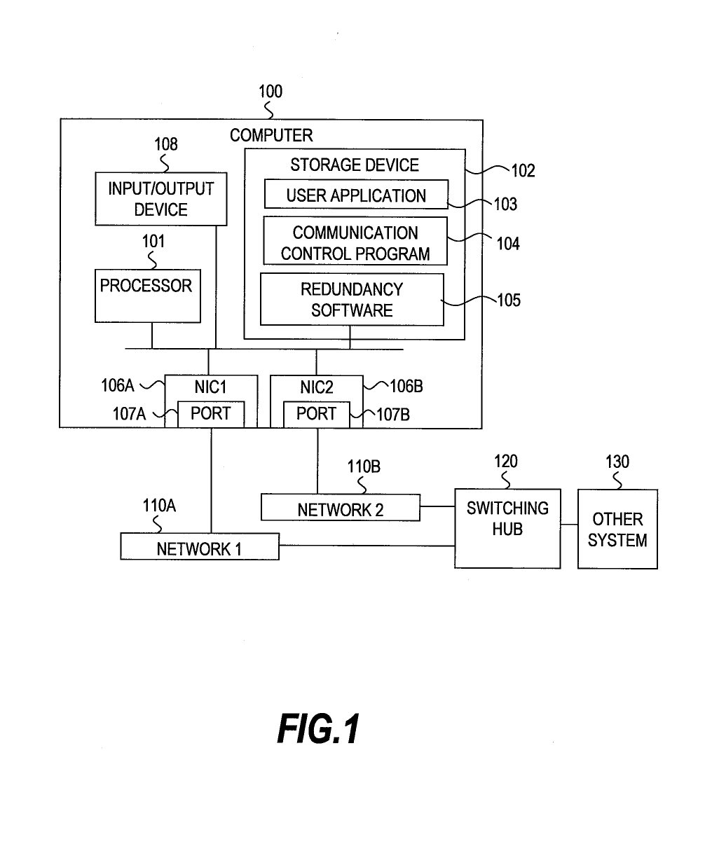

FIG. 1 is a block diagram showing a hardware configuration of a computer of an embodiment of this invention.

The computer 100 of the embodiment of this invention includes a processor 101, a storage device 102, and network interface cards (NIC) 1 106A and NIC2 106B, and an input-output device 108. The processor 101, the storage device 102, NIC1 106A, and NIC2 106 B are communicatably connected to each other.

The processor 101 executes various programs stored in the storage device 102.

The storage device 102 stores programs executed by the processor 101 and data referred to by the processor 101. The storage devices 102 may, for example, be a semiconductor memory, a magnetic disk unit, or combinations of them. The storage device 102 of this embodiment stores at least a user application 103, a communications control program 104, and redundancy software 105. Therefore, in descriptions below, processing executed by the user application 103, the communications control program 104, and the redundancy software 105 is actually executed by the processor 101 that executes the user application 103, the communications control program 104, and the redundancy software 105.

The computer 100 shown in FIG. 1 includes only one processor 101. However, the computer 100 may include plural processors 101. In that case, execution of the user application 103, the communication control program 104, and the redundancy software 105 may be shared by the plural processors 101.

The NIC1 106A and NIC2 106B are interfaces that allow the computer 100 to be connected to a network.

The computer 100 of this embodiment may be connected to any types of networks. FIG. 1 shows an example that the computer 100 is connected to the network 1 110A and network 2 110B. In this example, the NIC1 106A includes a port 107A connected to a network 1 110A. The NIC2 106B includes a port 107B connected to a network 2 110B.

Hereinafter, in descriptions common to both of the networks 1 110A and network 2 110B, these networks will be described simply as a network 110. Likewise, in descriptions common to both of the NIC1 106A and NIC2 106B, these NICs will be described simply as NIC 106. In descriptions common to both of the ports 107A and port 107B, these ports will be described simply as a port 107.

The network 1 110A and network 2 110B may be connected with other system 130 via a switching hub 120. The other system 130 may include, for example, another computer (not shown in the drawing). In the case, the computer 100 can communicate with the another computer via the network 110 and the switching hub 120.

Any communication protocols may be applied to the network 110. In this embodiment, for example, the Ethernet protocol is applied.

Though the computer 100 of FIG. 1 includes two NICs 106, actually, it may include three or more NICs 106.

The input-output device 108 may be an input device such as keyboard or mouse, an output device such as CRT or liquid crystal display, or a combination of them. A user of the computer 100 can input various information (e.g., arbitrary commands) to computer 100 by operating the input-output device 108. The inputted information is processed by the processor 101 that executes programs stored in the storage device 102. Furthermore, the processor 101 can display information in the input-output device 108.

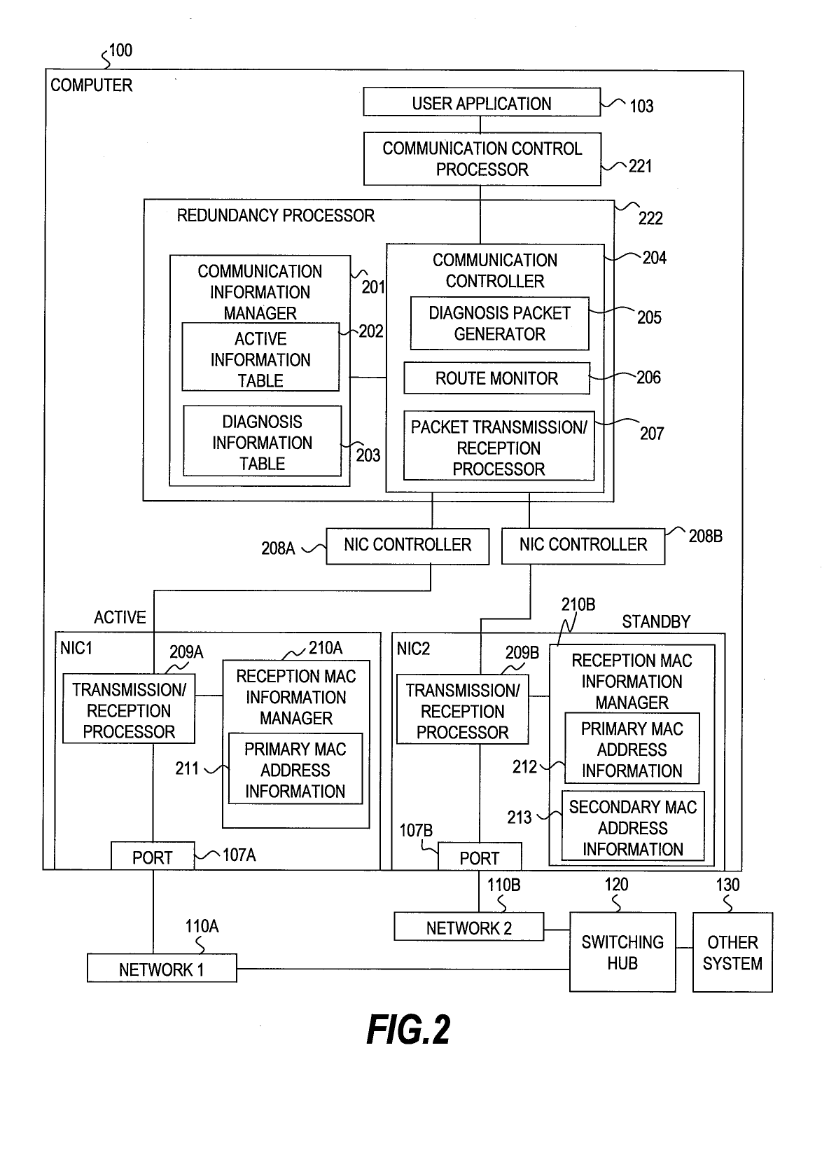

FIG. 2 is a functional block diagram of the computer of the embodiment of this invention.

Descriptions of portions already described in FIG. 1 of FIG. 2 are omitted.

The user application 103 is executed to provide the user of the computer 100 with various applications. The user application 103 executes data communication via the network 110 as required. At this time, the user application 103 uses a communication control processor 221.

The communication control processor 221 is a processing module realized by the processor 101 executing the communication control program 104. Or, the communication control processor 221 may also be dedicated hardware having the same function as the communication control program 104. The communication control processor 221 controls data communication according to requests from the user application 103. Specifically, for example, the communication control processor 221 may control communication by TCP/IP, or may control the communication by other protocols. For example, the communication control processor 221 may generate IP packets according to requests from the user application 103.

Packets transmitted and received by the user application 103 will be referred to as user packets. For example, packets generated by the communication control processor 221 according to requests from the user application 103, and transmitted from the NIC 106 are user packets. Packets which are received by the NIC 106 and pass through a communication controller 204 from the NIC 106 to pass their contents to the user application 103 are also user packets.

A redundancy processing module 222 is a processing module realized by the processor 101 executing the redundancy software 105. Or, the redundancy processing module 222 may also be dedicated hardware having the same function as the redundancy software 105. The redundancy processing module 222 makes redundant a route of data communication controlled by the communication control processor 221.

The redundancy processor 222 includes a communication information manager 201 and a communication controller 204. The communication information manager 201 and the communication controller 204 are, for example, program modules constituting the redundancy software 105. In this case, processing executed by the communication information manager 201 and the communication controller 204 is actually executed by the processor 101.

The communication information manager 201 manages an active information table 202 and a diagnosis information table 203. Information referred to by the communication controller 204 is registered in these tables. Information registered in these tables is stored in areas managed by the communication information manager 201 of storage areas in the storage device 102.

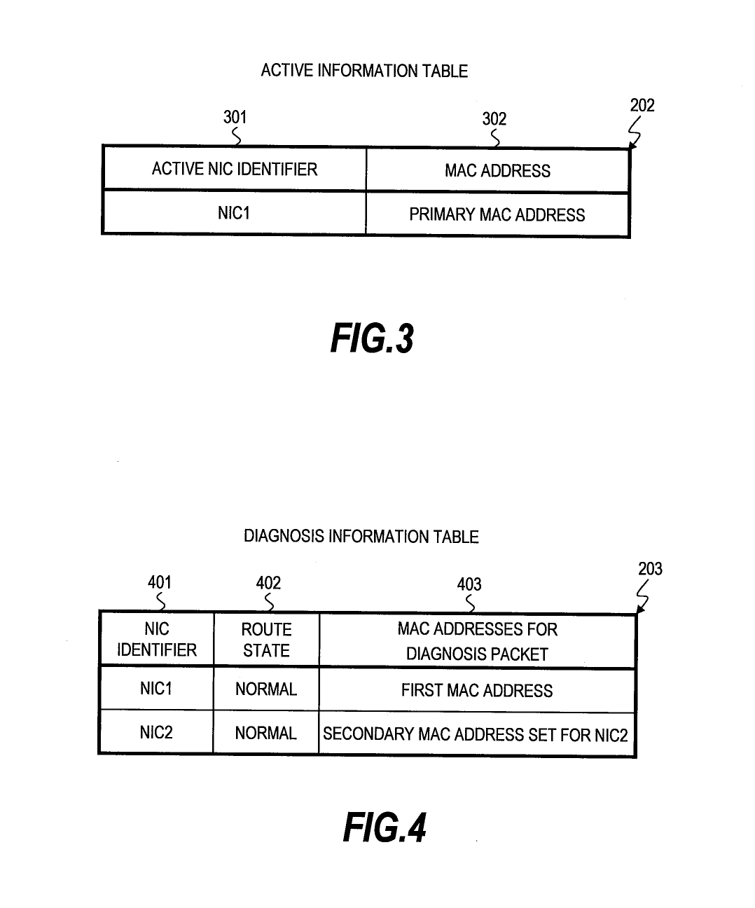

The active information table 202 and the diagnosis information table 203 will be detailed later (see FIGS. 3 and 4).

The communication controller 204 controls the transmission/reception of user packets, the transmission/reception of diagnosis packets, and the replacement of communication routes. The diagnosis packets are packets transmitted and received to monitor states of a communication route (e.g., whether a fault occurs in the communication route). To execute these controls, the communication controller 204 includes a diagnosis packet generator 205, a route monitor 206, and a packet transmission/reception processor 207. These are program modules constituting the communication controller 204. Therefore, processing executed by these program modules is actually executed by the processor 101.

The diagnosis packet generator 205 generates diagnosis packets.

The route monitor 206 monitors states of a communication route, based on response to a diagnosis packet.

The packet transmission/reception processor 207 executes transmission/reception processing of user packets and diagnosis packets.

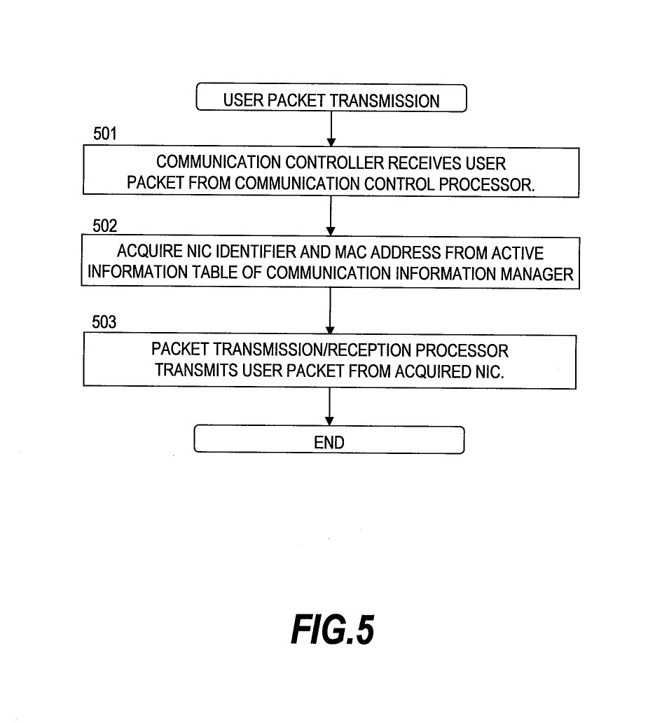

Details of processing executed by these modules will be given later (see FIGS. 5 to 9).

The NIC controllers 208A and 208B control NIC1 106A and NIC2 106B, respectively. The NIC controllers 208A and 208B may, for example, be realized by the processor 101 executing programs stored in the storage device 102.

The computer 100 of this embodiment includes two NIC 106, that is, NIC1 106A and NIC2 106B. One of the two NIC 106 is set as an active NIC, and the other as a standby NIC. In the example of FIG. 2, NIC1 106A is an active NIC, and NIC2 106B is a standby NIC. When the computer 100 includes three or more NICs 106, one NIC 106 is an active NIC, and all the rest are set as standby NIC. Information indicating the NIC 106 set as an active NIC is registered in the active information table 202.

The computer 100 transmits and receives user packets using the active NIC. Standby NIC is used in place of the active NIC when user packets cannot be transmitted or received using the active NIC. That is, while the active NIC transmits and receives user packets, the standby NIC transmits no user packet.

The NIC1 106A includes a transmission/reception processor 209A, a reception MAC information manager 210A, and a port 107A.

The transmission/reception processor 209A transmits and receives packets. Specifically, the transmission/reception processor 209A transmits and receives packets through the port 107A according to requests from the packet transmission/reception processor 207. The transmission/reception processor 209A may, for example, be a processor included in the NIC1 106A.

The reception MAC information manager 210A manages MAC addresses set in packets (i.e., Ethernet frames) received by the NIC1 106A. Specifically, the reception MAC information manager 210A holds information indicating the destination MAC addresses of packets received by the NIC1 106A. In the example of FIG. 2, the reception MAC information manager 210A holds primary MAC address information 211.

When a destination MAC address of a received packet matches a MAC address held by the reception MAC information manager 210A, the transmission/reception processor 209A passes the packet to the communication controller 204. On the other hand, when a destination MAC address of a received packet does not match a MAC address held by the reception MAC information manager 210A, the transmission/reception processor 209A discards the packet.

As has been already described, processing executed by the communication controller 204 is actually executed by the processor 101. Therefore, passing packets to the communication controller 204 from the NIC 106 is actually performed by the NIC 106 transmitting the packet to the processor 101. The transmission may be performed, for example, in such a way that the NIC 106 stores the packet in any storage area (e.g., a storage area in the storage device 102), and sends the address of the storage area to the processor 101.

The reception MAC information manager 210A may, for example, be a memory included in the NIC 1 106A or a part of the storage area of the memory.

The NIC2 106B includes a transmission/reception processor 209B, a reception MAC information manager 210B, and a port 107B. Since these are similar to the transmission/reception processor 209A, reception MAC information manager 210A, and port 107A, descriptions of them are omitted.

However, the reception MAC information manager 210B holds primary MAC address information 212 and secondary MAC address information 213. The primary MAC address information 212 indicates an address identical with the primary MAC address information 211. The secondary MAC address information 213 indicates an address different from the primary MAC address information 212. In this case, when a destination MAC address of a received packet matches an address indicated by either of the primary MAC address information 212 and the secondary MAC address information 213, the transmission/reception processor 209B passes the packet to the communication controller 204. On the other hand, when a destination MAC address of a received packet does not match an address indicated by any of the primary MAC address information 212 and the secondary MAC address information 213, the transmission/reception processor 209B discards the packet.

In FIG. 2, the NIC2 106B is standby NIC. Therefore, when receiving a user packet, the NIC2 106B may discard it without passing it to the communication controller 204. However, when a destination MAC address of the user packet is the same as a value indicated by the primary MAC address information 212, as described above, the NIC2 106B passes the received user packet to the communication controller 204. That is, the communication controller 204 receives the user packet from both of the active NIC and the standby NIC. In this case, the communication controller 204 refers to the active information table 202 and can discard user packets received from NIC 106 other than the active NIC.

FIG. 3 is an explanatory diagram of the active information table 202 of the embodiment of this invention.

The active information table 202 includes information on NIC 106 set as active NIC of plural NICs 106 included in the computer 100.

Specifically, the active information table 202 includes an active NIC identifier 301 and a MAC address 302.

As an active NIC identifier 301, the identifier of NIC 106 set as active NIC is registered.

As a MAC address 302, a MAC address used to transmit or receive user packets by the NIC 106 set as active NIC is registered.

In an example of FIG. 3, “NIC1” is registered in the active NIC identifier 301, and “primary MAC address” is registered in the MAC address 302. This indicates that NIC1 106A is set as active NIC, and a primary MAC address is set as a source MAC address of a user packet sent from NIC1 106A. The primary MAC address is the same as an address indicated by the primary MAC address information 211 held by the reception MAC information manager 210A of NIC1 106A in FIG. 2.

Information registered in the active information table 202 may be displayed in the input-output device 108 according to predetermined commands. For example, when a user of the computer 100 operates the input-output device 108 to input a predetermined command, the redundancy processor 222 that has received the command may display the content of the active information table 202 shown in FIG. 3 in the input-output device 108. By referring to the displayed information, the user can know which NIC 106 is used as an active NIC, and which address the active NIC uses for transmission/reception of a user packet. This function helps identify an active NIC, contributing to prevention of wrong operations on the active NIC.

FIG. 4 is an explanatory diagram of the diagnosis information table 203 of the embodiment of this invention.

The diagnosis information table 203 contains information on the diagnosis of communication routes.

Specifically, the diagnosis information table 203 includes NIC identifiers 401, route states 402, and MAC addresses for diagnosis packets 403.

The identifiers of NIC 106 included in the computer 100 are registered in the NIC identifier 401.

The result of checking the state of a communication route is registered in the route state 402.

In the MAC addresses for diagnosis packets 403, a value set as a source MAC address of a diagnosis packet transmitted by each NIC 106 is registered.

In the example of FIG. 4, “NIC1” and “NIC2” are registered as NIC identifiers 401. This indicates that the computer 100 includes NIC1 106A and NIC2 106B.

In the example of FIG. 4, “Normal” and “Primary MAC address” are registered respectively as the route state 402 and the MAC address for diagnosis packet 403 that correspond to the value “NIC1” of the NIC identifier 401. This indicates that the state of a communication route that passes through via NIC1 106A (that is, a communication route connected to NIC1 106A) is normal, and a primary MAC address is set as a source MAC address of a diagnosis packet transmitted from NIC1 106A. The primary MAC address is the same as an address indicated by the primary MAC address information 211 held by the reception MAC information manager 210A of NIC1 106A in FIG. 2.

In the example of FIG. 4, “Normal” and “Secondary MAC address set for NIC2” are registered respectively as the route state 402 and the MAC address 403 for diagnosis packet that correspond to the value “NIC2” of the NIC identifier 401. This indicates that the state of a communication route connected to NIC2 106B is normal, and a secondary MAC address is set as a source MAC address of a diagnosis packet transmitted from NIC2 106B. The secondary MAC address is the same as an address indicated by the secondary MAC address information 213 held by the reception MAC information manager 210B of NIC2 106B in FIG. 2.

Information registered in the diagnosis information table 203 may be displayed in the input-output device 108 according to predetermined commands. For example, when a user of the computer 100 operates the input-output device 108 to input a predetermined command, the redundancy processor 222 that has received the command may display the content of the diagnosis information table 203 shown in FIG. 4 in the input-output device 108. By referring to the displayed information, the user can know a state of a current communication route, and an address used by each NIC 106 for transmission/reception of a diagnosis packet. Since this function allows the user to know states of communication routes of a standby system, preventive maintenance can be performed for failures, if any, in the communication routes of the standby system.

FIG. 5 is a flowchart showing user packet transmission processing executed by the communication controller 204 of the embodiment of this invention.

In descriptions below, processing executed by programs and program modules is actually executed by the processor 101 that executes the programs and the like.

First, the communication controller 204 receives a user packet from the communication control processor 221 (Step 501). This user packet is generated, for example, by the communication control processor 221 according to a request from the user application 103.

Next, the communication controller 204 refers to the active information table 202 held by the communication information manager 201 to acquire the values of the NIC identifier 301 and the MAC address 302 of the active system (Step 502).

Next, the packet transmission/reception processor 207 of the communication controller 204 transmits the user packet received in Step 501 from the active NIC (NIC1 106A in the example of FIG. 3) indicated by the information acquired in Step 502 (Step 503). Specifically, the packet transmission/reception processor 207 sets the MAC address of the active NIC (the primary MAC address in the example of FIG. 3) in the source MAC address of the user packet received in Step 501. The packet transmission/reception processor 207 commands NIC1 106A to transmit the user packet via the NIC controller 208A.

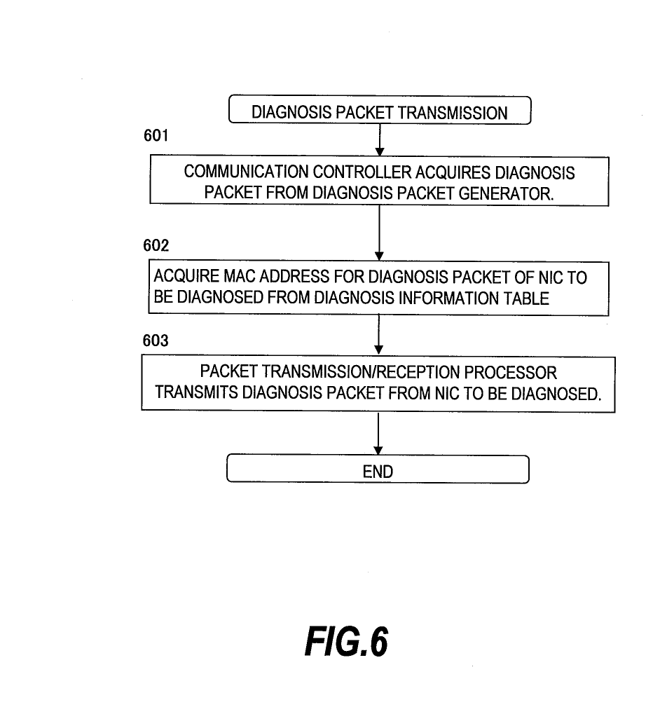

FIG. 6 is a flowchart showing diagnosis packet transmission processing executed by the communication controller 204 of the embodiment of this invention.

Processing of FIG. 6 diagnoses a communication route connected to any one of NIC 106. Hereinafter, NIC 106 connected to a communication route to be diagnosed will be described as NIC 106 to be diagnosed.

First, the communication controller 204 acquires a diagnosis packet from the diagnosis packet generator 205 (Step 601). Specifically, in Step 601, the diagnosis packet generator 205 generates a diagnosis packet.

Next, the communication controller 204 refers to the diagnosis information table 203 held by the communication information manager 201 to acquire the value of the MAC address for diagnosis packet 403 of the NIC 106 to be diagnosed (Step 602).

Next, the packet transmission/reception processor 207 of the communication controller 204 transmits the diagnosis packet received in Step 601 from the NIC 106 to be diagnosed (Step 603). Specifically, the packet transmission/reception processor 207 sets the MAC address acquired in Step 602 in the source MAC address of the diagnosis packet acquired in Step 601. The packet transmission/reception processor 207 commands the NIC 106 to be diagnosed to transmit the diagnosis packet via the NIC controller 208.

Ultimately, as shown in FIG. 2, when NIC1 106A is an active NIC and NIC2 106B is a standby NIC, the computer 100 transmits a user packet and a diagnosis packet from NIC1 106A, and transmits a diagnosis packet from NIC2 106B. As a source MAC address of a user packet transmitted from NIC1 106A, a primary MAC address registered in the MAC address 302 is set. As a source MAC address of a diagnosis packet transmitted from NIC1 106A, a primary MAC address registered in the MAC address for diagnosis packet 403 that corresponds to “NIC1” is set. As a source MAC address of a diagnosis packet transmitted from NIC2 106B, a secondary MAC address registered in the MAC address for diagnosis packet 403 that corresponds to “NIC2” is set.

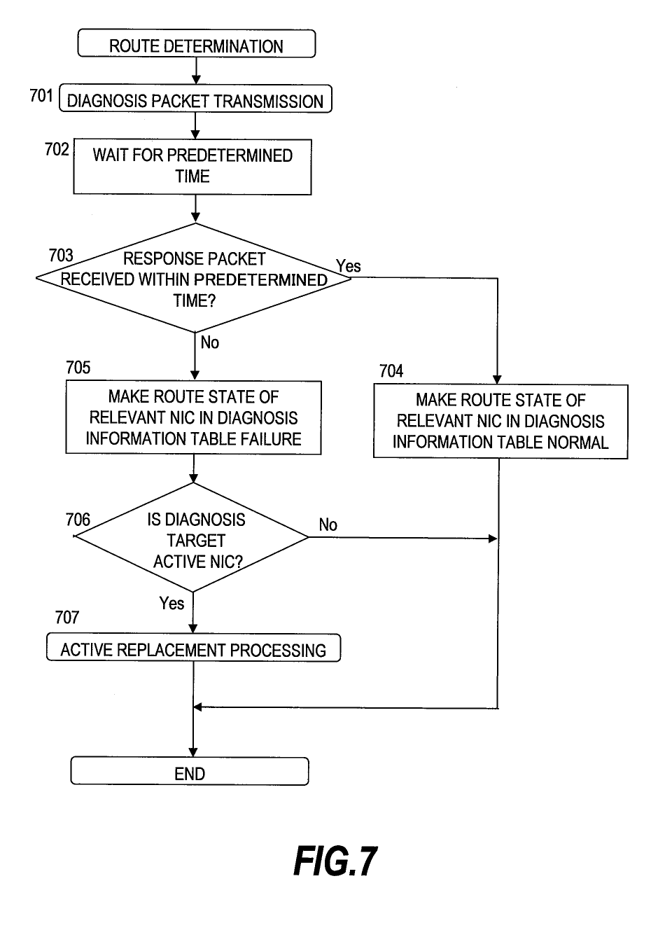

FIG. 7 is a flowchart showing route checking processing executed by the communication controller 204 of the embodiment of this invention.

The route checking processing shown in FIG. 7 is executed to determine whether the state of a communication route connected to NIC 106 is normal.

First, the communication controller 204 executes the diagnosis packet transmission processing described in FIG. 6 (Step 701). For example, in Step 701, the route monitor 206 of the communication controller 204 commands the start of diagnosis packet transmission processing, and according to the command, the diagnosis packet generator 205, the packet transmission/reception processor 207, and the like may execute the steps of FIG. 6.

Next, the route monitor 206 of the communication controller 204 waits for predetermined time (Step 702).

Next, the route monitor 206 determines whether it has received a response to the diagnosis packet transmitted in Step 701 within the predetermined time of the waiting in Step 702 (Step 703).

When it is determined in Step 703 that a response has been received within the predetermined time, it is determined that the state of the communication route to be diagnosed is normal. In this case, the route monitor 206 registers “Normal” in the route state 402 in the diagnosis information table 203 that corresponds to the NIC 106 to be diagnosed (Step 704), and terminates the processing.

On the other hand, when it is determined in Step 703 that no response has been received within the predetermined time, it is determined that the state of the communication route to be diagnosed is not normal (that is, failure). For example, when a fault occurs in the communication route to be diagnosed, such a determination is given. In this case, the route monitor 206 registers “Failure” in the route state 402 in the diagnosis information table 203 that corresponds to the NIC 106 to be diagnosed (Step 705). The computer 100 cannot communicate user packets with the other system 130 via a communication route determined as failure.

Next, the route monitor 206 determines whether the NIC 106 to be diagnosed is an active NIC (Step 706).

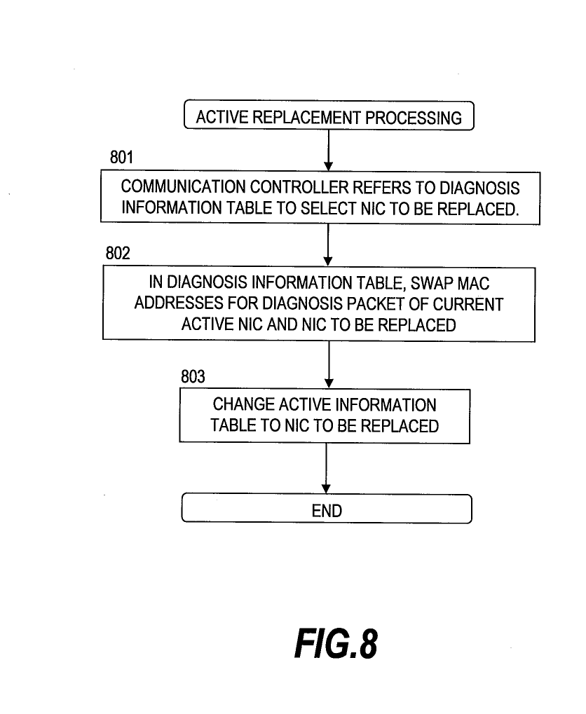

When it is determined in Step 706 that the NIC 106 to be diagnosed is determined as an active NIC, the state of a communication route connected to the active NIC is failure. Therefore, in this case, the computer 100 cannot communicate user packets with the other system 130. Therefore, the route monitor 206 executes active replacement processing (Step 707), and terminates the processing. The active replacement processing will be detailed with reference to FIG. 8.

On the other hand, in Step 706, when it is determined that the NIC 106 to be diagnosed is not an active NIC, the NIC 106 to be diagnosed is a standby NIC. The computer 100 does not use the standby NIC to transmit and receive user packets. Therefore, even if a fault occurs in a communication route connected to the standby NIC, if a communication route connected to the active NIC is normal, the computer 100 can transmit and receive user packets. Therefore, the route monitor 206 terminates the processing without executing Step 707.

The route checking processing shown in FIG. 7, to monitor states of communication routes, may be repeatedly executed at a predetermined timing with each NIC 106 as a target for diagnosis. For example, the route checking processing may be periodically executed.

FIG. 8 is a flowchart showing active replacement processing executed by the communication controller 204 of the embodiment of this invention.

When a state of a communication route connected to an active NIC shows failure, the active replacement processing is executed to set the active NIC as a new standby NIC, and a standby NIC as a new active NIC. By setting a standby NIC connected to a normal communication route as new active NIC, the computer 100 can again transmit and receive user packets.

First, the route monitor 206 of the communication controller 204 refers to the active information table 202 and the diagnosis information table 203 to select a replacement destination NIC (Step 801). The replacement destination NIC is NIC 106 to be set as a new active NIC.

For example, in Step 801, the route monitor 206, among identifiers registered in the NIC identifier 401 of the diagnosis information table 203, selects an identifier of standby NIC with “Normal” registered in the route state corresponding to it. The identifier of standby NIC is an identifier not registered in the active information table 202. In the example of FIG. 4, “NIC2” matching the condition is selected as a replacement destination NIC.

Next, the route monitor 206 updates the diagnosis information table 203, based on the selection in Step 801 (Step 802). Specifically, the route monitor 206 swaps a value registered in the MAC address for diagnosis packet 403 of the current active NIC for a value registered in the MAC address for diagnosis packet 403 of a replacement destination NIC. In the example of FIG. 4, “a secondary MAC address set for NIC1” is newly registered in the MAC address for diagnosis packet 403 that corresponds to “NIC1” (i.e., the identifier of the current active NIC). On the other hand, “primary MAC address” is newly registered in the MAC address for diagnosis packet 403 that corresponds to “NIC2”.

Next, the route monitor 206 updates the active information table 202, based on the selection in Step 801 (Step 803). Specifically, the route monitor 206 deletes a value registered in the active NIC identifier 301 of the active information table 202, and newly registers the identifier (e.g., “NIC2”) of the replacement destination NIC in the field.

This terminates the active replacement processing.

For example, in the computer system shown in FIG. 2, as a result of execution of the active replacement processing shown in FIG. 8, NIC1 106A becomes a new standby NIC, and NIC2 106B becomes a new active NIC. In this case, the computer 100 transmits user packets and diagnosis packets from NIC2 106B and transmits diagnosis packets from NIC1 106A. As a source MAC address of user packets transmitted from NIC2 106B, a primary MAC address registered in the MAC address 302 is set. As a source MAC address of diagnosis packets transmitted from NIC2 106B, a primary MAC address registered in the MAC address for diagnosis packet 403 that corresponds to “NIC2” is set. As a source MAC address of diagnosis packets transmitted from NIC1 106A, a secondary MAC address registered in the MAC address for diagnosis packet 403 that corresponds to “NIC1” is set.

As described above, NIC1 106A that has newly become a standby NIC transmits a diagnosis packet with a secondary MAC address set as a source MAC address. When the state of a communication route connected to NIC1 106A has become normal, NIC1 106A receives a response packet to the transmitted diagnosis packet. However, as a destination MAC address of the response packet, the secondary MAC address being the source of the diagnosis packet is set. Therefore, as long as the reception MAC information manager 210A holds only the primary MAC address information 211, NIC1 106A discards the received response packet. Therefore, the route monitor 206 cannot know that NIC1 106A has received the response packet, that is, that the state of the communication route connected to NIC1 106A has became normal.

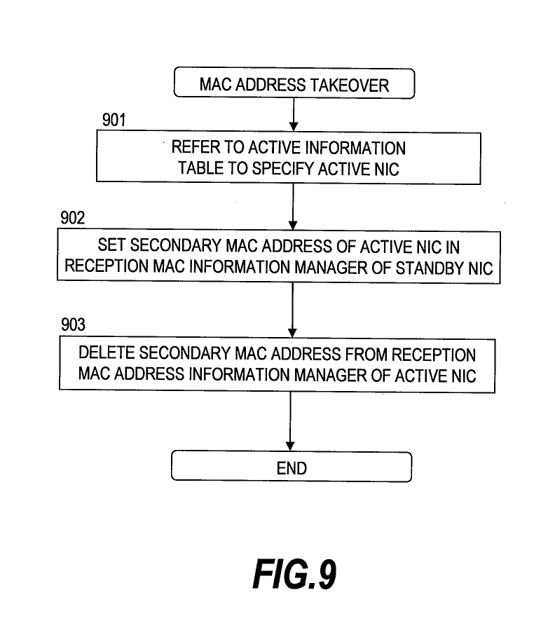

To pass the response packet received by NIC1 106A to the communication controller 204 without discarding it, the reception MAC information manager 210A must hold the address set as the source MAC address of the diagnosis packet transmitted by NIC1 106A. Processing executed for this is described with reference to FIG. 9.

FIG. 9 is a flowchart showing MAC address takeover processing executed by the communication controller 204 of the embodiment of this invention.

First, the route monitor 206 of the communication controller 204 refers to the active information table 202 to specify an active NIC (Step 901). Specifically, the identifier registered in the active information table 202 is the identifier of the active NIC.

Next, the route monitor 206 sets the secondary MAC address set in the active NIC in the reception MAC information manager 210 of standby NIC (Step 902). For example, as a result of the processing shown in FIG. 8, when NIC2 106B is a new active NIC, the route monitor 206 copies the secondary MAC address information 213 held by the reception MAC information manager 210B to the reception MAC information manager 210A of NIC1 106A that is standby NIC (see FIG. 2).

Processing of Step 902 may be realized, for example, in such a way that the route monitor 206 refers to the diagnosis information table 203, and transmits to the standby NIC the command to hold values registered in the MAC address for diagnosis packet 403 of the standby NIC in the reception MAC information manager 210.

Next, the route monitor 206 deletes the secondary MAC address copied in Step 902 from the reception MAC information manager 210 of active NIC (Step 903). For example, in Step 902, when the secondary MAC address information 213 is copied from the reception MAC information manager 210B to the reception MAC information manager 210A, the route monitor 206, in Step 903, deletes the secondary MAC address information 213 from the reception MAC information manager 210B.

Processing of Step 903 may be realized, for example, in such a way that the route monitor 206 refers to the diagnosis information table 203 and transmits to the active NIC the command to delete a value registered in the MAC address for diagnosis packet 403 that corresponds to the standby NIC from the reception MAC information manager 210.

This terminates the MAC address takeover processing.

As a result of the MAC address takeover processing shown in FIG. 9, the reception MAC information manager 210A of NIC1 106A being a new standby NIC holds secondary MAC address information 213 in addition to primary MAC address information 211. As a result, when NIC1 106A receives a response packet to a diagnosis packet transmitted by NIC1 106A, it can pass it the communication controller 204 without discarding it.

Therefore, it is desirable that the MAC address takeover processing is executed until a new standby NIC set by the active replacement processing receives the first response packet after it is determined that the state of a communication route connected to an active NIC is not normal. For example, in FIG. 7, the MAC address takeover processing may be executed immediately after it is determined that the state of the communication route connected to the active NIC is not normal (Step 706), or immediately after the active replacement processing (Step 707) has been executed.

However, in the point in time, processing in each NIC 106 may be congested with the active replacement processing or processing related to it. In this case, if the MAC address takeover processing is further executed, further congestion of processing may reduce the performance of NIC 106. As described above, since the MAC address takeover processing may be executed until a new standby NIC receives a first response packet, it does not always need to be executed immediately after the active replacement processing has been executed. Therefore, the MAC address takeover processing may be executed to avoid processing congestion by the active replacement processing.

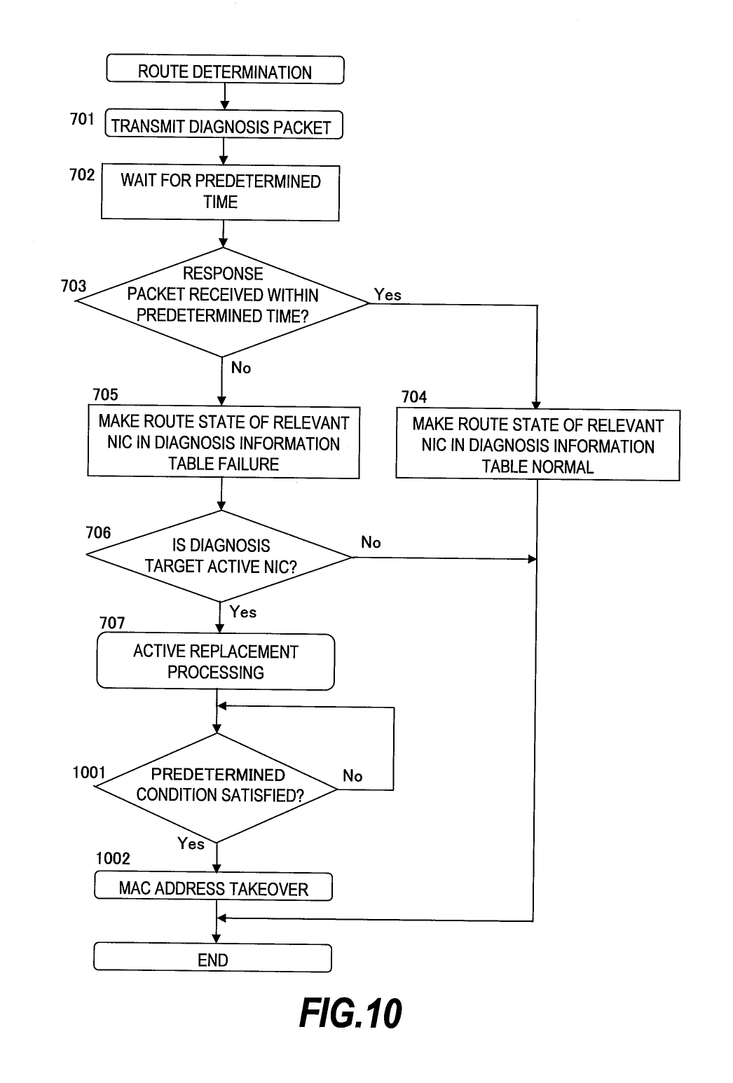

FIG. 10 is a flowchart showing an example of execution timing of the MAC address takeover processing in the embodiment of this invention.

Since Steps 701 to 707 of FIG. 10 are the same as those of FIG. 7, descriptions of them are omitted.

In the example of FIG. 10, the route monitor 206, after the active replacement processing (Step 707) has been executed, determines whether a predetermined condition is satisfied (Step 1001). When it is determined in Step 1001 that the predetermined condition is not satisfied, the route monitor 206 waits until the predetermined condition is satisfied. When it is determined in Step 1001 that the predetermined condition is satisfied, the route monitor 206 executes the MAC address takeover processing (Step 1002).

It is desirable that the predetermined condition in Step 1001 is set so that MAC address takeover processing is executed to avoid processing congestion by the active replacement processing. For example, when predetermined time has elapsed after it is determined that the state of a communication route connected to the active NIC is not normal (Step 706), it may be determined that the predetermined condition is satisfied. Or, when predetermined time has elapsed after execution of the active replacement processing (Step 707) terminates, it may be determined that the predetermined condition is satisfied. Or, after execution of the active replacement processing (Step 707) terminates (or after it is determined that the state of a communication route connected to the active NIC is not normal), the load of NIC 106 is monitored, and when the value of the load is lower than a predetermined threshold, it may be determined that the predetermined condition is satisfied. Or, after execution of the active replacement processing (Step 707) terminates, when a new standby NIC receives a request to transmit a diagnosis packet from the communication controller 204, it may be determined that the predetermined condition is satisfied.

On the other hand, the reception MAC information managers 210A and 210B always hold the primary MAC address information 211 and 212 that have values identical to each other. Therefore, from immediately after the active replacement processing has been executed, the communication controller 204 can transmit and receive user packets via a new active NIC.

Hereinbefore, according to the embodiment of this invention, the active and the standby NICs included in the computer 100 have identical MAC addresses used to transmit and receive user packets. Furthermore, the standby NIC holds MAC addresses used to transmit and receive diagnosis packets that are different from MAC addresses used to transmit and receive user packets. When the computer 100 includes plural standby NICs, MAC addresses used to transmit and receive diagnosis packets held in the standby NICs are different from each other. The active NIC uses MAC addresses used to transmit and receive user packets to transmit and receive the user packets and diagnosis packets.

Therefore, the computer 100 can monitor states of communication routes connected to all NICs 106 by using unique MAC addresses among the active NIC and all standby NICs to transmit diagnosis packets, and receiving response packets to them.

Furthermore, the computer 100, when the state of a communication route connected to the active NIC becomes failure, executes the active replacement processing to set one of standby NICs as a new active NIC. The new active NIC previously holds MAC addresses used to transmit and receive user packets. Therefore, the computer 100 can quickly start the transmission/reception of user packets by using the new active NIC.

Furthermore, after the active replacement processing is executed, the computer 100 copies MAC addresses used by the new active NIC when the new active NIC is standby NIC for the transmission/reception of diagnosis packets to a new standby NIC. As a result, even after executing the active replacement processing, the computer 100 can monitor states of communication routes connected to all NICs 106 by using unique MAC addresses among the active NIC and all standby NICs to transmit diagnosis packets, and receiving response packets to them. By the computer 100 executing the copying of MAC addresses to avoid congestion of processing of NIC 106, reduction in NIC 106 performance due to further congestion can be prevented.

According to the embodiment of this invention, active and standby interfaces each use unique addresses to transmit diagnosis packets. Thereby, states of respective communication routes can be monitored. Furthermore, when the state of a communication route connected to an active interface becomes failure, by setting a standby interface as a new active interface, transmission and reception of user packets can be quickly started.

While the present invention has been described in detail and pictorially in the accompanying drawings, the present invention is not limited to such detail but covers various obvious modifications and equivalent arrangements, which fall within the purview of the appended claims.

What is claimed is:

1. A computer comprising plural interfaces coupled to a network, a processor coupled to the plural interfaces, and a storage device coupled to the processor,
wherein the plural interfaces include a first interface and a second interface,
wherein the first interface holds a first address, and when the destination address of a packet received by the first interface matches the first address, transmits the received packet to the processor,
wherein the second interface holds the first address and a second address, and when the destination address of a packet received by the second interface matches the first address or the second address, transmits the received packet to the processor, and
wherein the processor:
transmits a packet having the first address as a source address from the first interface;
transmits a packet having the second address as a source address from the second interface; and
when it is determined that a state of a communication route on the network that is coupled to the first interface is not normal, transmits a packet having the first address as a source address from the second interface.

2. The computer according to claim 1,
wherein, when not receiving a response to the transmitted packet having the first address as a source address within a first predetermined time after transmitting the packet from the first interface, the processor determines that a state of the communication route coupled to the first interface is not normal, and
wherein, when not receiving a response to the transmitted packet having the second address as a source address within the first predetermined time after transmitting the packet from the second interface, the processor determines that a state of a communication route on the network that is coupled to the second interface is not normal.

3. The computer according to claim 1,
wherein when it is determined that a state of the communication route coupled to the first interface is not normal, the processor:
holds the second address in the first interface;
transmits a packet having the second address as a source address from the first interface; and
when not receiving a response to the packet transmitted from the first interface within the first predetermined time, determines that a state of the communication route coupled to the first interface is not normal.

4. The computer according to claim 3,
wherein the processor holds the second address in the first interface when a predetermined condition is satisfied after it is determined that a state of the communication route coupled to the first interface is not normal.

5. The computer according to claim 4,
wherein after it is determined that a state of the communication route coupled to the first interface is not normal, when a second predetermined time has elapsed, the predetermined condition is satisfied.

6. A computer readable medium storing a program that controls a computer,
wherein the computer comprises plural interfaces coupled to a network, a processor coupled to the plural interfaces, and a storage device coupled to the processor,
wherein the plural interfaces include a first interface and a second interface,
wherein the first interface holds a first address, and when a destination address of a packet received by the first interface matches the first address, transmits the received packet to the processor,
wherein the second interface holds the first address and a second address, and when a destination address of a packet received by the second interface matches the first address or the second address, transmits the received packet to the processor, and
wherein the program instructs the processor to execute:
a step of transmitting a packet having the first address as a source address from the first interface;
a step of transmitting a packet having the second address as a source address from the second interface; and
a step of transmitting, when it is determined that a state of a communication route on the network that is coupled to the first interface is not normal, a packet having the first address as a source address from the second interface.

7. The computer readable medium storing the program according to claim 6, further instructing the processor to execute:
a step of determining, when not receiving a response to the transmitted packet having the first address as a source address within a first predetermined time after transmitting the packet from the first interface, that a state of the communication route coupled to the first interface is not normal; and
a step of determining, when not receiving a response to the transmitted packet having the second address as a source address within the first predetermined time after transmitting the packet from the second interface, that a state of a communication route on the network that is coupled to the second interface is not normal.

8. The computer readable medium storing the program according to claim 6,
wherein when it is determined that a state of the communication route coupled to the first interface is not normal, the program further instructs the processor to execute:
a step of holding the second address in the first interface;
a step of transmitting a packet having the second address as a source address from the first interface; and
a step of determining, when not receiving a response to the packet transmitted from the first interface within the first predetermined time, that a state of the communication route coupled to the first interface is not normal.

9. The computer readable medium storing the program according to claim 8,
wherein the program further instructs the processor to execute a step of holding the second address in the first interface when a predetermined condition is satisfied after it is determined that a state of the communication route coupled to the first interface is not normal.

10. The computer readable medium storing the program according to claim 9,
wherein after it is determined that a state of the communication route coupled to the first interface is not normal, when a second predetermined time has elapsed, the predetermined condition is satisfied.

11. A method for controlling a computer comprising plural interfaces coupled to a network, a processor coupled to the plural interfaces, and a storage device coupled to the processor,
wherein the plural interfaces include a first interface and a second interface,
wherein the first interface holds a first address, and when the destination address of a packet received by the first interface matches the first address, transmits the received packet to the processor,
wherein the second interface holds the first address and a second address, and when the destination address of a packet received by the second interface matches the first address or the second address, transmits the received packet to the processor, and
wherein the method includes the steps of:
transmitting a packet having the first address as a source address from the first interface by the processor;
transmitting a packet having the second address as a source address from the second interface by the processor; and
when it is determined that a state of a communication route on the network that is coupled to the first interface is not normal, transmitting a packet having the first address as a source address from the second interface by the processor.

12. The method according to claim 11, further including the steps of:
when a response to the transmitted packet having the first address as a source address is not received within a first predetermined time after the packet is transmitted from the first interface, determining, by the processor, that a state of the communication route coupled to the first interface is not normal; and
when a response to the transmitted packet having the second address as a source address is not received within the first predetermined time after the packet is transmitted from the second interface, determining, by the processor, that a state of a communication route on the network that is coupled to the second interface is not normal.

13. The method according to claim 11,
wherein when it is determined that a state of the communication route coupled to the first interface is not normal, the method further include the steps of:
holding, by the processor, the second address in the first interface;
transmitting, by the processor, a packet having the second address as a source address from the first interface; and
when not receiving a response to the packet transmitted from the first interface within the first predetermined time, determining, by the processor, that a state of the communication route coupled to the first interface is not normal.

14. The method according to claim 13,
wherein the step of holding the second address in the first interface is executed when a predetermined condition is satisfied after it is determined that a state of the communication route coupled to the first interface is not normal.

15. The method according to claim 13,
wherein the predetermined condition is satisfied when a second predetermined time has elapsed after it is determined that a state of the communication route coupled to the first interface is not normal.
